(19) United States
(12) Patent Application Publication
(10) Pub. No.: US 2007/0269586 A1
(43) Pub. Date: Nov. 22, 2007

(54) METHOD OF MAKING LIGHT EMITTING DEVICE WITH SILICON-CONTAINING COMPOSITION

(75) Inventors: Catherine A. Leatherdale, St. Paul, MN (US); D. Scott Thompson, Woodbury, MN (US); Larry D. Boardman, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/383,916

(22) Filed: May 17, 2006

(51) Int. Cl. B05D 5/06

(52) U.S. Cl. 427/66; 427/532

(57) ABSTRACT

A method of making a light emitting device is disclosed. The method includes providing a light emitting diode; providing an optical element; attaching the optical element to the light emitting diode with a photopolymerizable composition, the photopolymerizable composition comprising a silicon-containing resin and a metal-containing catalyst, wherein the silicon-containing resin comprises silicon-bonded hydrogen and aliphatic unsaturation; and applying actinic radiation having a wavelength of 700 nm or less to initiate hydrosilylation within the silicon-containing resin.

### FIELD OF THE INVENTION

The invention relates to a method of making a light emitting device, and particularly, to a method of attaching an optical element to a light emitting diode (LED) with a photopolymerizable silicon-containing composition.

### BACKGROUND

Light emitting devices comprising LEDs are desirable light sources in part because of their relatively small size, low power/current requirements, rapid response time, long life, robust packaging, variety of available output wavelengths, and compatibility with modern circuit boards. These characteristics may help explain their widespread use over the past few decades in a multitude of different end use applications. Improvements to LEDs continue to be made in the areas of efficiency, brightness, and output wavelength, further enlarging the scope of potential end-use applications.

There is a need for photochemically and thermally stable compositions that may be used to make light emitting devices comprising LEDs. In particular, there is a need for materials that may be used to attach optical components to LEDs.

### SUMMARY

A method of making a light emitting device is disclosed herein. The method includes providing an LED; providing an optical element; attaching the optical element to the light emitting diode with a photopolymerizable composition, the photopolymerizable composition comprising a silicon-containing resin and a metal-containing catalyst, wherein the silicon-containing resin comprises silicon-bonded hydrogen and aliphatic unsaturation; and applying actinic radiation having a wavelength of 700 nm or less to initiate hydrosilylation within the silicon-containing resin. The actinic radiation may be applied before, after, or before and after the optical element is attached.

The method disclosed herein provides a light emitting device comprising an LED with an optical element attached thereto. The optical element may comprise a lens, an optical film such as a multilayer optical film or brightness enhancing film, a phosphor-reflector assembly, or a combination thereof. The light emitting device may comprise an LED mounted in a variety of ways such as in a ceramic or polymeric package, or on a circuit board. The optical element may contact the LED or it may be spaced apart from the LED.

The method provides a way to attach an optical element to an LED using a photopolymerizable composition with relatively rapid cure mechanisms even at relatively low temperatures.

These and other aspects of the invention will be apparent from the detailed description below. In no event, however, should the above summary be construed as a limitation on the claimed subject matter, which subject matter is defined solely by the attached claims, as may be amended during prosecution.

### BRIEF DESCRIPTION OF THE DRAWINGS

The invention may be more completely understood in consideration of the following detailed description and examples in connection with the figures described below. The figures, in no event, should be construed as limitations on the claimed subject matter, which subject matter is defined solely by the claims as set forth herein.

FIG. 1 shows exemplary light emitting devices wherein the optical element is a lens and the LED is surface mounted.

FIG. 2 shows an exemplary light emitting device wherein the optical element is a lens and the LED is in a recessed cavity.

FIG. 3 shows exemplary light emitting devices wherein the optical element is a phosphor-reflector assembly.

FIG. 4 shows an exemplary light emitting device wherein the optical element is a ball lens.

FIG. 5 shows an exemplary light emitting device wherein the optical element is an extractor.

### DETAILED DESCRIPTION

Disclosed herein is a method for preparing a light emitting device comprising an optical element attached to an LED with a photopolymerizable silicon-containing composition. In general, silicon-containing resins are advantageous because of their thermal and photochemical stability. Silicon-containing resins typically comprise organosiloxanes that are cured either by acid-catalyzed condensation reactions between silanol groups bonded to the organosiloxane components or by metal-catalyzed hydrosilylation reactions between groups incorporating aliphatic unsaturation and silicon-bonded hydrogen which are bonded to the organosiloxane components. In the first instance, the curing reaction is relatively slow, sometimes requiring many hours to proceed to completion. In the second instance, to achieve desirable levels of cure in a relatively short time, temperatures significantly in excess of room temperature are normally required.

The method disclosed herein also utilizes organosiloxane compositions that are cured by metal-catalyzed hydrosilylation reactions between groups incorporating aliphatic unsaturation and silicon-bonded hydrogen, which are bonded to the organosiloxane components. However, the metal-containing catalysts used herein can be activated by actinic radiation. The advantages of using radiation-activated hydrosilylation to cure the photopolymerizable composition include (1) the ability to cure the photopolymerizable composition without subjecting the LED, the substrate to which it is attached, or any other materials present in the package or system, to potentially harmful temperatures, (2) the ability to formulate one-part photopolymerizable compositions that display long working times in the absence of inhibitors (also known as bath life or shelf life), (3) the ability to cure the photopolymerizable composition on demand at the discretion of the user, and (4) the ability to simplify the formulation process by avoiding the need for two-part formulations as is typically required for thermally curable hydrosilylation compositions.

The disclosed method involves the use of actinic radiation having a wavelength of less than or equal to 700 nanometers (nm). Thus, the disclosed methods are particularly advantageous to the extent they avoid harmful temperatures. Preferably, the disclosed methods involve the application of actinic radiation at a temperature of less than 120° C., more preferably, at a temperature of less than 60° C., and still more preferably at a temperature of 25° C. or less. In general, it may be desirable for the photopolymerizable composition to be at a temperature of from about 30° C. to about 120° C. while actinic radiation is applied, for example, in order to lower the viscosity of the photopolymerizable composition, facilitate the release of any entrapped gas, or accelerate curing.

Actinic radiation used in the disclosed methods includes light of a wide range of wavelengths less than or equal to 700 nm, including visible and UV light, but preferably, the actinic radiation has a wavelength of 600 nm or less, and more preferably from 200 to 600 nm., and even more preferably, from 250 to 500 nm. Preferably, the actinic radiation has a wavelength of at least 200 nm, and more preferably at least 250 nm.

A sufficient amount of actinic radiation may be applied before attaching the optical element to the LED. A sufficient amount may be enough to at least partially cure the photopolymerizable composition; a partially cured composition means that at least 5 mole percent of the aliphatic unsaturation is consumed in a hydrosilylation reaction. A sufficient amount may also be enough to at least substantially cure the photopolymerizable composition; a substantially cured composition means that greater than 60 mole percent of the aliphatic unsaturation present in the reactant species prior to reaction has been consumed as a result of the light activated addition reaction of the silicon-bonded hydrogen with the aliphatic unsaturated species. Preferably, such curing occurs in less than 30 minutes, more preferably in less than 10 minutes, and even more preferably in less than 5 minutes. In certain embodiments, such curing can occur in seconds.

A sufficient amount of actinic radiation may be applied after attaching the optical element to the LED. A sufficient amount may be enough to at least partially cure the photopolymerizable composition; a partially cured composition means that at least 5 mole percent of the aliphatic unsaturation is consumed in a hydrosilylation reaction. A sufficient amount may also be enough to at least substantially cure the photopolymerizable composition; a substantially cured composition means that greater than 60 mole percent of the aliphatic unsaturation present in the reactant species prior to reaction has been consumed as a result of the light activated addition reaction of the silicon-bonded hydrogen with the aliphatic unsaturated species. Preferably, such curing occurs in less than 30 minutes, more preferably in less than 10 minutes, and even more preferably in less than 5 minutes. In certain embodiments, such curing can occur in seconds.

Examples of sources of actinic radiation include those of a very wide range. These include tungsten halogen lamps, xenon arc lamps, mercury arc lamps, incandescent lamps, germicidal lamps, and fluorescent lamps. In certain embodiments, the source of actinic radiation is the LED.

In some cases, depending on the particular components in the photopolymerizable composition, the actinic radiation may be applied after the optical element is attached to the LED, but not before. Alternatively, it may be applied before the optical element is attached, but not after. In some cases, the actinic radiation may be applied both before and after attaching the optical element to the LED.

In some cases, the method may further comprise heating in a separate step, i.e., in the absence of applying actinic radiation. Heating may be applied before or after actinic radiation is applied, and before or after the optical element and LED are attached. If applied, heating may be at less than 150° C., or more preferably at less than 120° C., and still more preferably at less than 60° C.

Heating may be carried out in order to lower the viscosity of the photopolymerizable composition, for example, to facilitate the release of any entrapped gas. Heat may optionally be applied during or after application of the actinic radiation to accelerate curing. Heat may also be applied to gel the silicon-containing resin and control settling of any additional components such as particles, phosphors, etc. which may be present in the photopolymerizable composition. Controlled settling of the particles or phosphors may be used to achieve specific useful spatial distributions of the particles or phosphors within the photopolymerizable composition. For example, the method may allow controlled settling of particles enabling formation of a gradient refractive index distribution that may enhance LED efficiency or emission pattern. It may also be advantageous to allow partial settling of phosphor such that a portion of the photopolymerizable composition is clear and other portions contain phosphor. In this case, the clear portion of photopolymerizable composition can be shaped to act as a lens for the emitted light from the phosphor.

The silicon-containing resin can include monomers, oligomers, polymers, or mixtures thereof. It includes silicon-bonded hydrogen and aliphatic unsaturation, which allows for hydrosilylation (i.e., the addition of a silicon-bonded hydrogen across a carbon-carbon double bond or triple bond). The silicon-bonded hydrogen and the aliphatic unsaturation may or may not be present in the same molecule. Furthermore, the aliphatic unsaturation may or may not be directly bonded to silicon.

Preferred silicon-containing resins can be in the form of a liquid, gel, elastomer, or a non-elastic solid, and are thermally and photochemically stable. For UV light, silicon-containing resins having refractive indices of at least 1.34 are preferred. For some embodiments, silicon-containing resins having refractive indices of at least 1.50 are preferred.

Preferred silicon-containing resins are selected such that they provide a photopolymerized composition that is photostable and thermally stable. Herein, photostable refers to a material that does not chemically degrade upon prolonged exposure to actinic radiation, particularly with respect to the formation of colored or light absorbing degradation products. Herein, thermally stable refers to a material that does not chemically degrade upon prolonged exposure to heat, particularly with respect to the formation of colored or light absorbing degradation products. In addition, preferred silicon-containing resins are those that possess relatively rapid cure mechanisms (e.g., seconds to less than 30 minutes) in order to accelerate manufacturing times and reduce overall LED cost.

Examples of suitable silicon-containing resins are disclosed, for example, in U.S. Pat. Nos. 6,376,569 (Oxman et al.), 4,916,169 (Boardman et al.), 6,046,250 (Boardman et al.), 5,145,886 (Oxman et al.), 6,150,546 (Butts), and in U.S. Pat. Appl. Nos. 2004/0116640 (Miyoshi). A preferred silicon-containing resin comprises an organosiloxane (i.e., silicones) which includes organopolysiloxanes. Such resins typically include at least two components, one having silicon-bonded hydrogen and one having aliphatic unsaturation. However, both silicon-bonded hydrogen and olefinic unsaturation may exist within the same molecule.

In one embodiment, the silicon-containing resin can include a silicone component having at least two sites of aliphatic unsaturation (e.g., alkenyl or alkynyl groups) bonded to silicon atoms in a molecule and an organohydrogensilane and/or organohydrogenpolysiloxane component having at least two hydrogen atoms bonded to silicon atoms in a molecule. Preferably, a silicon-containing resin includes both components, with the silicone containing aliphatic unsaturation as the base polymer (i.e., the major organosiloxane component in the composition.) Preferred silicon-containing resins are organopolysiloxanes. Such resins typically comprise at least two components, at least one of which contains aliphatic unsaturation and at least one of which contains silicon-bonded hydrogen. Such organopolysiloxanes are known in the art and are disclosed in such patents as U.S. Pat. No. 3,159,662 (Ashby), U.S. Pat. No. 3,220,972 (Lamoreauz), U.S. Pat. No. 3,410,886 (Joy), U.S. Pat. No. 4,609,574 (Keryk), U.S. Pat. No. 5,145,886 (Oxman, et. al), and U.S. Pat. No. 4,916,169 (Boardman et. al). Curable one component organopolysiloxane resins are possible if the single resin component contains both aliphatic unsaturation and silicon-bonded hydrogen.

Organopolysiloxanes that contain aliphatic unsaturation are preferably linear, cyclic, or branched organopolysiloxanes comprising units of the formula R¹ₐR²_{b}SiO_{(4-a-b)/2} wherein: R¹ is a monovalent, straight-chained, branched or cyclic, unsubstituted or substituted hydrocarbon group that is free of aliphatic unsaturation and has from 1 to 18 carbon atoms; R² is a monovalent hydrocarbon group having aliphatic unsaturation and from 2 to 10 carbon atoms; a is 0, 1, 2, or 3; b is 0, 1, 2, or 3; and the sum a+b is 0, 1, 2, or 3; with the proviso that there is on average at least 1 R² present per molecule.

Organopolysiloxanes that contain aliphatic unsaturation preferably have an average viscosity of at least 5 mPa·s at 25° C.

Examples of suitable R¹ groups are alkyl groups such as methyl, ethyl, n-propyl, iso-propyl, n-butyl, iso-butyl, tert-butyl, n-pentyl, iso-pentyl, neo-pentyl, tert-pentyl, cyclopentyl, n-hexyl, cyclohexyl, n-octyl, 2,2,4-trimethylpentyl, n-decyl, n-dodecyl, and n-octadecyl; aromatic groups such as phenyl or naphthyl; alkaryl groups such as 4-tolyl; aralkyl groups such as benzyl, 1-phenylethyl, and 2-phenylethyl; and substituted alkyl groups such as 3,3,3-trifluoro-n-propyl, 1,1,2,2-tetrahydroperfluoro-n-hexyl, and 3-chloro-n-propyl.

Examples of suitable R² groups are alkenyl groups such as vinyl, 5-hexenyl, 1-propenyl, allyl, 3-butenyl, 4-pentenyl, 7-octenyl, and 9-decenyl; and alkynyl groups such as ethynyl, propargyl and 1-propynyl. In the present invention, groups having aliphatic carbon-carbon multiple bonds include groups having cycloaliphatic carbon-carbon multiple bonds.

Organopolysiloxanes that contain silicon-bonded hydrogen are preferably linear, cyclic or branched organopolysiloxanes comprising units of the formula R¹ₐH_{c}SiO_{(4-a-c)/2} wherein: R¹ is as defined above; a is 0, 1, 2, or 3; c is 0, 1, or 2; and the sum of a+c is 0, 1, 2, or 3; with the proviso that there is on average at least 1 silicon-bonded hydrogen atom present per molecule.

Organopolysiloxanes that contain silicon-bonded hydrogen preferably have an average viscosity of at least 5 mPa·s at 25° C.

Organopolysiloxanes that contain both aliphatic unsaturation and silicon-bonded hydrogen preferably comprise units of both formulae R¹ₐR²_{b}SiO_{(4-a-b)/2} and R¹ₐH_{c}SiO_{(4-a-c)/2}. In these formulae, R¹, R², a, b, and c are as defined above, with the proviso that there is an average of at least 1 group containing aliphatic unsaturation and 1 silicon-bonded hydrogen atom per molecule.

The molar ratio of silicon-bonded hydrogen atoms to aliphatic unsaturation in the silicon-containing resin (particularly the organopolysiloxane resin) may range from 0.5 to 10.0 mol/mol, preferably from 0.8 to 4.0 mol/mol, and more preferably from 1.0 to 3.0 mol/mol.

For some embodiments, organopolysiloxane resins described above wherein a significant fraction of the R¹ groups are phenyl or other aryl, aralkyl, or alkaryl are preferred, because the incorporation of these groups provides materials having higher refractive indices than materials wherein all of the R¹ radicals are, for example, methyl.

The photopolymerizable composition comprises a metal-containing catalyst which enables the cure of the silicon-containing resin via radiation-activated hydrosilylation. These catalysts are known in the art and typically include complexes of precious metals such as platinum, rhodium, iridium, cobalt, nickel, and palladium. The precious metal-containing catalyst preferably contains platinum. Disclosed compositions can also include a cocatalyst, i.e., the use of two or more metal-containing catalysts.

A variety of such catalysts is disclosed, for example, in U.S. Pat. Nos. 6,376,569 (Oxman et al.), 4,916,169 (Boardman et al.), 6,046,250 (Boardman et al.), 5,145,886 (Oxman et al.), 6,150,546 (Butts), 4,530,879 (Drahnak), 4,510,094 (Drahnak) 5,496,961 (Dauth), 5,523,436 (Dauth), 4,670,531 (Eckberg), as well as International Publication No. WO 95/025735 (Mignani).

Certain preferred platinum-containing catalysts are selected from the group consisting of Pt(II) β-diketonate complexes (such as those disclosed in U.S. Pat. No. 5,145,886 (Oxman et al.), (η⁵-cyclopentadienyl)tri(σ-aliphatic)platinum complexes (such as those disclosed in U.S. Pat. No. 4,916,169 (Boardman et al.) and U.S. Pat. No. 4,510,094 (Drahnak)), and C₇₋₂₀-aromatic substituted (η⁵-cyclopentadienyl)tri(σ-aliphatic)platinum complexes (such as those disclosed in U.S. Pat. No. 6,150,546 (Butts).

Such catalysts are used in an amount effective to accelerate the hydrosilylation reaction. Such catalysts are preferably included in the photopolymerizable composition in an amount of at least 1 part, and more preferably at least 5 parts, per one million parts of the photopolymerizable composition. Such catalysts are preferably included in the photopolymerizable composition in an amount of no greater than 1000 parts of metal, and more preferably no greater than 200 parts of metal, per one million parts of the photopolymerizable composition.

In addition to the silicon-containing resins and catalysts, the photopolymerizable composition can also include nonabsorbing metal oxide particles, semiconductor particles, phosphors, sensitizers, photoinitiators, antioxidants, catalyst inhibitors, and pigments. If used, such additives are used in amounts to produced the desired effect.

Particles that are included within the photopolymerizable composition can be surface treated to improve dispersibility of the particles in the resin. Examples of such surface treatment chemistries include silanes, siloxanes, carboxylic acids, phosphonic acids, zirconates, titanates, and the like. Techniques for applying such surface treatment chemistries are known.

Nonabsorbing metal oxide and semiconductor particles can optionally be included in the photopolymerizable composition in order to increase its refractive index. Suitable nonabsorbing particles are those that are substantially transparent over the emission bandwidth of the LED. Examples of nonabsorbing metal oxide and semiconductor particles include, but are not limited to, Al₂O₃, ZrO₂, TiO₂, V₂O₅, ZnO, SnO₂, ZnS, SiO₂, and mixtures thereof, as well as other sufficiently transparent non-oxide ceramic materials such as semiconductor materials including such materials as ZnS, CdS, and GaN. Silica (SiO₂), having a relatively low refractive index, may also be useful as a particle material in some applications, but, more significantly, it can also be useful as a thin surface treatment for particles made of higher refractive index materials, to allow for more facile surface treatment with organosilanes. In this regard, the particles can include species that have a core of one material on which is deposited a material of another type. If used, such nonabsorbing metal oxide and semiconductor particles are preferably included in the photopolymerizable composition in an amount of no greater than 85 wt-%, based on the total weight of the photopolymerizable composition. Preferably, the nonabsorbing metal oxide and semiconductor particles are included in the photopolymerizable composition in an amount of at least 10 wt-%, and more preferably in an amount of at least 45 wt-%, based on the total weight of the photopolymerizable composition. Generally the particles can range in size from 1 nanometer to 1 micron, preferably from 10 nanometers to 300 nanometers, more preferably, from 10 nanometers to 100 nanometers. This particle size is an average particle size, wherein the particle size is the longest dimension of the particles, which is a diameter for spherical particles. It will be appreciated by those skilled in the art that the volume percent of metal oxide and/or semiconductor particles cannot exceed 74 percent by volume given a monomodal distribution of spherical particles.

Phosphors can optionally be included in the photopolymerizable composition to adjust the color emitted from the LED. As described herein, a phosphor consists of a fluorescent material. The fluorescent material could be inorganic particles, organic particles, or organic molecules or a combination thereof. Suitable inorganic particles include doped garnets (such as YAG:Ce and (Y,Gd)AG:Ce), aluminates (such as Sr₂Al₁₄O₂₅:Eu, and BAM:Eu), silicates (such as SrBaSiO:Eu), sulfides (such as ZnS:Ag, CaS:Eu, and SrGa₂S₄:Eu), oxy-sulfides, oxy-nitrides, phosphates, borates, and tungstates (such as CaWO₄). These materials may be in the form of conventional phosphor powders or nanoparticle phosphor powders. Another class of suitable inorganic particles is the so-called quantum dot phosphors made of semiconductor nanoparticles including Si, Ge, CdS, CdSe, CdTe, ZnS, ZnSe, ZnTe, PbS, PbSe, PbTe, InN, InP, InAs, AlN, AlP, AlAs, GaN, GaP, GaAs and combinations thereof. Generally, the surface of each quantum dot will be at least partially coated with an organic molecule to prevent agglomeration and increase compatibility with the binder. In some cases the semiconductor quantum dot may be made up of several layers of different materials in a core-shell construction. Suitable organic molecules include fluorescent dyes such as those listed in U.S. Pat. No. 6,600,175 (Baretz et al.). Preferred fluorescent materials are those that exhibit good durability and stable optical properties. The phosphor layer may consist of a blend of different types of phosphors in a single layer or a series of layers, each containing one or more types of phosphors. The inorganic phosphor particles in the phosphor layer may vary in size (e.g., diameter) and they may be segregated such that the average particle size is not uniform across the cross-section of the siloxane layer in which they are incorporated. If used, the phosphor particles are preferably included in the photopolymerizable composition in an amount of no greater than 85 wt-%, and in an amount of at least 1 wt-%, based on the total weight of the photopolymerizable composition. The amount of phosphor used will be adjusted according to the thickness of the siloxane layer containing the phosphor and the desired color of the emitted light.

Sensitizers can optionally be included in the photopolymerizable composition to both increase the overall rate of the curing process (or hydrosilylation reaction) at a given wavelength of initiating radiation and/or shift the optimum effective wavelength of the initiating radiation to longer values. Useful sensitizers include, for example, polycyclic aromatic compounds and aromatic compounds containing a ketone chromaphore (such as those disclosed in U.S. Pat. No. 4,916,169 (Boardman et al.) and U.S. Pat. No. 6,376,569 (Oxman et al.)). Examples of useful sensitizers include, but are not limited to, 2-chlorothioxanthone, 9,10-dimethylanthracene, 9,10-dichloroanthracene, and 2-ethyl-9,10-dimethylanthracene. If used, such sensitizers are preferably included in the photopolymerizable composition in an amount of no greater than 50,000 parts by weight, and more preferably no greater than 5000 parts by weight, per one million parts of the composition. If used, such sensitizers are preferably included in the photopolymerizable composition in an amount of at least 50 parts by weight, and more preferably at least 100 parts by weight, per one million parts of the composition.

Photoinitiators can optionally be included in the photopolymerizable composition to increase the overall rate of the curing process (or hydrosilylation reaction). Useful photoinitiators include, for example, monoketals of α-diketones or α-ketoaldehydes and acyloins and their corresponding ethers (such as those disclosed in U.S. Pat. No. 6,376,569 (Oxman et al.)). If used, such photoinitiators are preferably included in the photopolymerizable composition in an amount of no greater than 50,000 parts by weight, and more preferably no greater than 5000 parts by weight, per one million parts of the composition. If used, such photoinitiators are preferably included in the photopolymerizable composition in an amount of at least 50 parts by weight, and more preferably at least 100 parts by weight, per one million parts of the composition.

Catalyst inhibitors can optionally be included in the photopolymerizable composition to further extend the usable shelf life of the composition. Catalyst inhibitors are known in the art and include such materials as acetylenic alcohols (for example, see U.S. Pat. Nos. 3,989,666 (Niemi) and 3,445,420 (Kookootsedes et al.)), unsaturated carboxylic esters (for example, see U.S. Pat. Nos. 4,504,645 (Melancon), 4,256,870 (Eckberg), 4,347,346 (Eckberg), and 4,774,111 (Lo)) and certain olefinic siloxanes (for example, see U.S. Pat. Nos. 3,933,880 (Bergstrom), 3,989,666 (Niemi), and 3,989,667 (Lee et al.). If used, such catalyst inhibitors are preferably included in the photopolymerizable composition in an amount not to exceed the amount of the metal-containing catalyst on a mole basis.

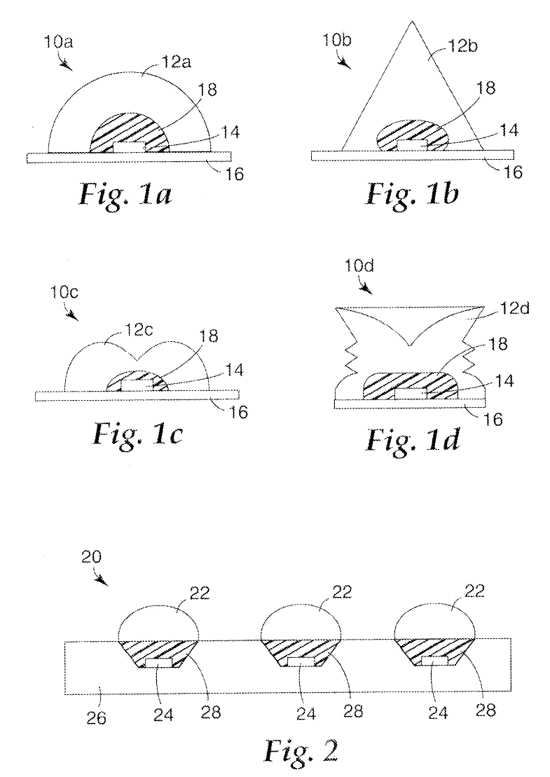

The optical element may comprise a lens to control the directionality of light in some way, typically upwards and away and/or at the sides of the light emitting device. Exemplary light emitting devices 10 comprising exemplary lenses 12 are shown in FIG. 1. LED 14 is shown mounted on substrate 16, but other configurations as described below are possible. For clarity, other features such as electrical connections are not shown. The lens may comprise a simple lens having a spherical surface such as a hemispherical shape 12a, or it may be shaped as a polyhedron such as a prism having a triangular 12b, rectangular, or hexagonal shape. Other useful shapes include cusps 12c, cones, horns, or toroids. The optical element may also comprise a complex lens having some combination of convex and/or concave surfaces, for example, an aplanatic lens. The lens may also comprise a combination of shapes, for example, it may have sawtooth-like shapes and a cusp shape 12d.

In general, the lens comprises a transparent material such as a polymer, glass, quartz, fused silica, ceramic, or the like. The lens may have a refractive index typically in the range of from about 1.4 to about 1.6, preferably about 1.5 to 1.55, depending on the particular lens.

The lens is typically prefabricated, and as shown in FIG. 1, it may have a concave underside. In this case, the lens may be placed in contact with the photopolymerizable composition 18 while it is in a deformable state (not completely cured) and positioned relative to the LED such that air and excess composition are expelled. As shown in FIG. 2, lens 22 may have a planar underside that is positioned in contact with the photopolymerizable composition 28.

A fluorescent material may be incorporated into the light emitting device for converting the color of at least some of the light emitted by the light emitting diode. For example, the fluorescent material may be dispersed throughout the photopolymerizable material or disposed on the underside of the lens that is adjacent the photopolymerizable material.

The optical element may comprise an optical film that can manage light such that the light is intentionally enhanced, manipulated, controlled, maintained, transmitted, reflected, refracted, absorbed, etc. Examples of optical films include reflective polarizing films, absorbing polarizing films, retro-reflective films, light guides, diffusive films, brightness enhancement films, glare control films, protective films, privacy films, or a combination thereof.

The optical film may comprise any material suitable for use in optical applications. Exemplary properties include optical effectiveness over diverse portions of the ultraviolet, visible, and infrared regions, optical clarity, high index of refraction, durability, and environmental stability. In some cases, the optical film may be substantially specular, absorbing substantially no light over a predetermined wavelength region of interest; i.e., substantially all light over the region that falls on the surface of a first or second optical layer is reflected or transmitted.

Typically, the optical film comprises a condensation or addition polymer, a blend thereof, or a polymer that is some combination thereof. Examples of condensation polymers include polyesters, polycarbonates, cellulose acetate esters, polyurethanes, polyamides, polyimides, poly(meth)acrylates, and the like. Examples of addition polymers include poly(meth)acrylates, polystyrenes, polyolefins, polypropylene, cyclic olefins, epoxies, polyvinyl chloride, polyvinylidene fluoride, polyethers, cellulose acetates, polyethersulfone, polysulfone, fluorinated ethylenepropylene (FEP), and the like. The optical films may also comprise polymers derived from metal-catalyzed polymerizations such as polyorganosiloxanes formed by hydrosilylation reactions.

The optical film may comprise multilayer optical films such as polarizers, e.g., reflective polarizers comprising hundreds of alternating layers of two different polymeric materials. Materials used in multilayer optical films include crystalline, semi-crystalline, or amorphous polymers such as, for example, PEN/co-PEN, PET/co-PEN, PEN/sPS, PET/sPS, PEN/ESTAR, PET/ESTAR, PEN/EDCEL, PET/EDCEL, PEN/THV, and PEN/co-PET wherein PEN is polyethylene naphthalate, co-PEN comprises a copolymer or blend based upon naphthalene dicarboxylic acid, PET comprises polyethylene terphthalate, sPS comprises syndiotactic polystyrene, and ESTAR comprises a polycyclohexanedimethylene terephthalate from Eastman Chemical Co., EDCEL comprises a thermoplastic polymer from Eastman Chemical Col, THV is a fluoropolymer from 3M Company, and co-PET comprises a copolymer or blend based upon terephthalic acid. The entire thickness of the multilayer optical film is desirably from 5 to 2,000 μm. Manufacturing methods include any of several known processes such as extrusion, coextrusion, coating, and lamination.

Multilayer optical films are described in U.S. Pat. No. 5,882,774; U.S. Pat. No. 5,828,488; U.S. Pat. No. 5,783,120; U.S. Pat. No. 6,080,467; U.S. Pat. No. 6,368,699 B1; U.S. Pat. No. 6,827,886 B2; U.S. 2005/0024558 A1; U.S. Pat. No. 5,825,543; U.S. Pat. No. 5,867,316; or U.S. Pat. No. 5,751,388; or U.S. Pat. No. 5,540,978. Examples include any of the dual brightness enhancement film (DBEF) products or any of the diffusely reflective polarizing film (DRPF) products available from 3M Company under the Vikuiti™ brand, including DBEF-E, DBEF-D200 and DBEF-D440 multilayer reflective polarizers.

In one particular example, the multilayer optical film comprises a short pass reflector capable of reflecting visible light and transmitting UV light, or a long pass reflector capable of reflecting UV light and transmitting visible light; these reflectors are described in US 2004/145913 A1, the disclosure of which is incorporated herein by reference for all that it contains.

The optical film may also comprise a phosphor layer, diffusive layer, matte layer, abrasion resistant layer, layer for chemical or UV protection, support layer, magnetic shield layer, adhesive layer, primer layer, skin layer, dichroic polarizer layer, or combinations thereof. Examples of useful support layers include polycarbonate, polyester, acrylic, metal, or glass. The one or more additional layers may be extruded with other layers of the optical film, coated, or laminated.

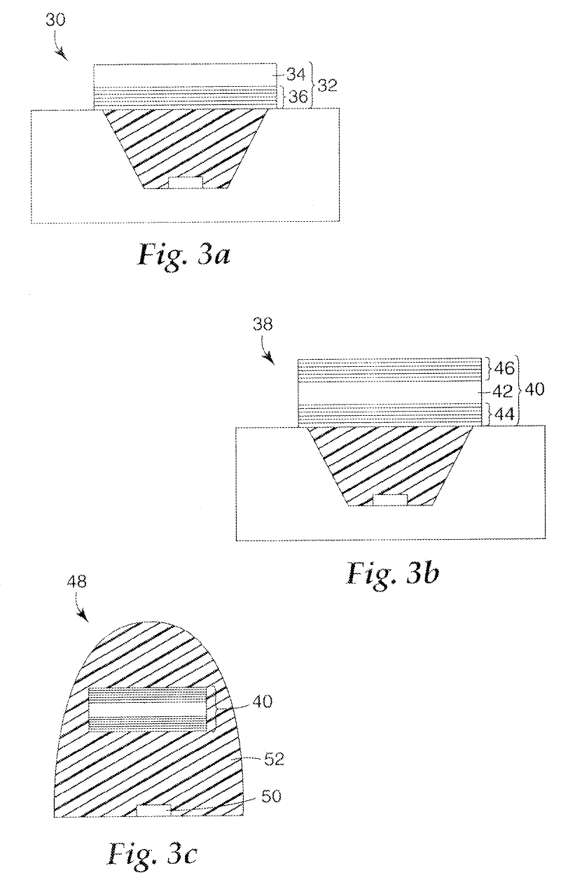

In a particular example, as shown in FIG. 3a, light emitting device 30 comprises a phosphor-reflector assembly 32 as the optical film. The phosphor-reflector assembly comprises a layer of a phosphor material 34 disposed on reflector 36, which may be a short pass reflector or a long pass reflector. The layer of a phosphor material emits visible light when illuminated by light emitted by the LED and transmitted through the reflector. In another particular example, as shown in FIG. 3b, light emitting device 38 comprises a phosphor-reflector assembly 40, the phosphor reflector assembly comprising a layer of phosphor material 42 disposed between two reflectors 44 and 46. One reflector may be a short pass reflector and the other a long pass reflector, for example, reflector 44 may be the short pass reflector and reflector 46 may be the long pass reflector.

The optical film may comprise a brightness enhancement film having a microstructured surface, the microstructured surface comprising an array of prism elements. These optical films recycle light through a process of reflection and refraction that ultimately helps to direct light toward a viewer (usually positioned directly in front of the display device) that would otherwise leave the screen at a high angle, missing the viewer. A comprehensive discussion of the behavior of light in a brightness enhancement film may be found, for example, in U.S. Ser. No. 11/283,307. Examples include the Vikuiti™ BEFII and BEFIII family of prismatic films available from 3M Company, St. Paul, Minn., including BEFII 90/24, BEFII 90/50, BEFIIIM 90/50, and BEFIIIT. Brightness enhancement films can act as retro-reflecting films or elements for use therewith.

The microstructured surface may also comprise, for example, a series of shapes including ridges, posts, pyramids, hemispheres and cones, and/or they may be protrusions or depressions having flat, pointed, truncated, or rounded parts, any of which may have angled or perpendicular sides relative to the plane of the surface. Any lenticular microstructure may be useful, for example, the microstructured surface may comprise cube corner elements, each having three mutually substantially perpendicular optical faces that typically intersect at a single reference point, or apex. The microstructured surface may have a regularly repeating pattern, be random, or a combination thereof. In general, the microstructured surface comprises one or more features, each feature having at least two lateral dimensions (i.e. dimensions in the plane of the film) less than 2 mm.

In some cases, such as for optical films having a microstructured surface as described below, the layer may be made by coating a flowable composition onto a microstructured tool or liner and then hardening the composition. For example, the flowable composition may be radiation curable and comprise a reactive diluent, oligomer, crosslinker, and an optional photoinitiator which are hardened or cured by application of UV, electron beam, or some other kind of radiation after coating onto the microstructured tool or liner. For another example, the flowable composition may be a composition that is made flowable at an elevated temperature and then cooled after coating onto the microstructured tool or liner. Examples of useful radiation curable compositions are described below for a microstructured layer.

The microstructured layer may be prepared using a polymerizable composition, a master having a negative microstructured molding surface, and a preformed second optical layer sometimes referred to as a base layer. The polymerizable composition is deposited between the master and the second optical layer, either one of which is flexible, and a bead of the composition is moved so that the composition fills the microstructures of the master. The polymerizable composition is polymerized to form the layer and is then separated from the master. The master can be metallic, such as nickel, nickel-plated copper or brass, or can be a thermoplastic material that is stable under polymerizing conditions and that preferably has a surface energy that permits clean removal of the polymerized layer from the master. The microstructured layer may have a thickness of from about 10 to about 200 um.

The polymerizable composition may comprise monomers including mono-, di-, or higher functional monomers, and/or oligomers, and preferably, those having a high index of refraction, for example, greater than about 1.4 or greater than about 1.5. The monomers and/or oligomers may be polymerizable using UV radiation. Suitable materials include (meth)acrylates, halogenated derivatives, telechelic derivatives, and the like, and as described in U.S. Pat. Nos. 4,568,445; 4,721,377; 4,812,032; 5,424,339; and U.S. Pat. No. 6,355,754; all incorporated by reference herein. A preferable polymerizable composition is described in U.S. Ser. No. 10/747,985, filed on Dec. 30, 2003, and which is incorporated herein by reference. This polymerizable composition comprises a first monomer comprising a major portion of 2-propenoic acid, (1-methylethylidene)bis[(2,6-dibromo-4,1-phenylene)oxy(2-hydroxy-3,1-propanediyl)]ester; pentaerythritol tri(meth)acrylate; and phenoxyethyl (meth)acrylate.

The particular choice of materials used for the polymerizable composition will depend upon the method used to form the microstructured layer, for example, viscosity may be an important factor. The particular application in which the brightness enhancement film will be employed may also be considered, for example, the film needs to have particular optical properties yet be physically and chemically durable over time.

The second optical layer in a brightness enhancement film may be described as a base layer. This layer may comprise any material suitable for use in an optical product, i.e., one that is optically clear and designed to control the flow of light. Depending on the particular application, the second optical layer may need to be structurally strong enough so that the brightness enhancement film may be assembled into an optical device. Preferably, the second optical layer adheres well to the first optical layer and is sufficiently resistant to temperature and aging such that performance of the optical device is not compromised over time. Materials useful for the second optical layer include polyesters such as polyethylene terephthalate, polyethylene naphthalate, copolyesters or polyester blends based on naphthalene dicarboxylic acids; polycarbonates; polystyrenes; styrene-acrylonitriles; cellulose acetates; polyether sulfones; poly(methyl)acrylates such as polymethylmethacrylate; polyurethanes; polyvinyl chloride; polycyclo-olefins; polyimides; glass; or combinations or blends thereof. The second optical layer may also comprise a multilayered optical film as described above and in U.S. Pat. No. 6,111,696.

The optical element may also comprise optical elements including those described as extractors or optical concentrators, in U.S. Ser. Nos. 10/977,577, 10/977,225, 10/977,248, 10/977,241, 11/027,404, 11/381,324, 11/381,329, 11/381,332, 11/381,984 (Attorney docket nos. 60217, 60218, 60219, 60296, 62044, 62076, 62080, 62081, and 62082), and US 2005/0023545 A1, the disclosures of which are incorporated herein by reference for all that they contain. These optical elements can be used to aid extraction of light from the LED to the surrounding medium as well as to modify the emission pattern of the light. These optical elements typically have a refractive index of about 1.75 or greater and comprise glass, diamond, silicone carbide, sapphire, zirconia, zinc oxide, polymer, or a combination thereof.

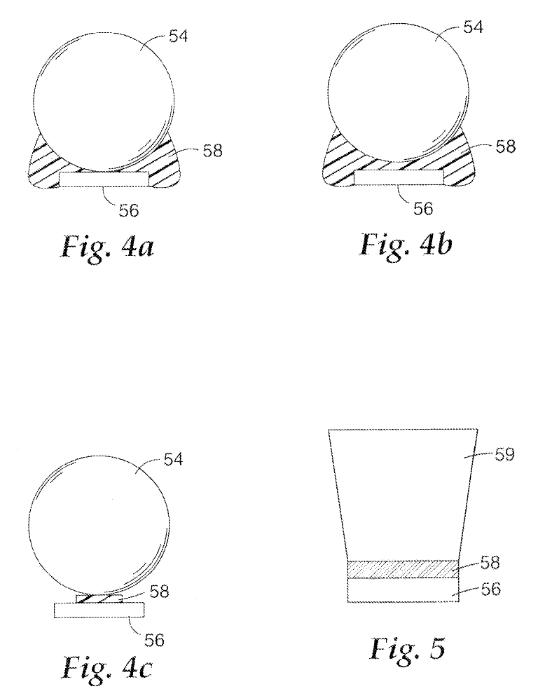

The optical element and the LED may be attached to each other in just about any relative configuration as long as the resulting light emitting device functions as desired. FIG. 4 shows examples of how an exemplary optical element, ball lens 42, may be attached to LED 44 with photopolymerized composition 46. In FIG. 4a, the ball lens and LED are in contact with each other such that attaching the optical element to the light emitting diode comprises contacting the optical element and light emitting diode. In FIG. 4b, they are physically close together and spaced apart from each other such that attaching the optical element to the light emitting diode comprises positioning the optical element within 100 nm of the light emitting diode. In both cases, the two are held together by the photopolymerized composition 46. In most cases, it is desirable for the optical element to be optically coupled to the LED, which is typically the case when the two are physically close together, for example, when they within 100 nm of each other.

In FIG. 4c, the optical element 54 and LED 56 are attached by a small amount of the photopolymerized composition 58. In FIG. 5, the optical element is an extractor 59, and the extractor is attached to LED 56 with photopolymerized composition 58. Alternatively, the photopolymerizable composition may be an encapsulant such that attaching the optical element to the light emitting diode comprises encapsulating the light emitting diode. The optical element could then be attached to any part of the encapsulant, for example, on an upper surface, or it could even be buried within the encapsulant, as shown in FIG. 3c. In FIG. 3c, light emitting device 48 comprises LED 50 encapsulated with photopolymerized composition 52, and embedded in the photopolymerized composition is phosphor-reflector assembly 40. The light emitting device shown in FIG. 3c may be referred to as a phosphor based light source, or PLED, and is described, for example, in US 2004/0145913 A1, US 2004/0145288, and US 2004/0144987, the disclosures of which are incorporated herein by reference. The photopolymerizable composition may also be used to encapsulant an array of LEDs surface mounted on a variety of substrates.

The light emitting device described herein comprises an LED that emits light, whether visible, ultraviolet, or infrared. It includes encapsulated semiconductor devices marketed as “LEDs”, whether of the conventional or super-radiant variety. Vertical cavity surface emitting laser diodes are another form of LED. An “LED die” is an LED in its most basic form, i.e., in the form of an individual component or chip made by semiconductor wafer processing procedures. The component or chip can include electrical contacts suitable for application of power to energize the device. The individual layers and other functional elements of the component or chip are typically formed on the wafer scale, the finished wafer finally being diced into individual piece parts to yield a multiplicity of LED dies.

Useful LEDs include monochrome and phosphor-LEDs (in which blue or UV light is converted to another color via a fluorescent phosphor). The LEDs may be surface mounted or side mounted, in ceramic or polymeric packages either of which may or may not have a reflecting cup, or they may be mounted on circuit boards, or on plastic electronic substrates.

LED emission light can be any light that an LED source can emit and can range from the UV to the infrared portions of the electromagnetic spectrum depending on the composition and structure of the semiconductor layers. Where the source of the actinic radiation is the LED itself, LED emission is preferably in the range from 350-500 nm.

The photopolymerized composition described herein is resistant to thermal and photodegradation (resistant to yellowing) and thus are particularly useful for white light sources (i.e., white light emitting devices). White light sources that utilize LEDs in their construction can have two basic configurations. In one, referred to herein as direct emissive LEDs, white light is generated by direct emission of different colored LEDs. Examples include a combination of a red LED, a green LED, and a blue LED, and a combination of a blue LED and a yellow LED. In the other basic configuration, referred to herein as LED-excited phosphor-based light sources (PLEDs), a single LED generates light in a narrow range of wavelengths, which impinges upon and excites a phosphor material to produce visible light. The phosphor can comprise a mixture or combination of distinct phosphor materials, and the light emitted by the phosphor can include a plurality of narrow emission lines distributed over the visible wavelength range such that the emitted light appears substantially white to the unaided human eye.

An example of a PLED is a blue LED illuminating a phosphor that converts blue to both red and green wavelengths. A portion of the blue excitation light is not absorbed by the phosphor, and the residual blue excitation light is combined with the red and green light emitted by the phosphor. Another example of a PLED is an ultraviolet (UV) LED illuminating a phosphor that absorbs and converts UV light to red, green, and blue light. It will be apparent to one skilled in the art that competitive absorption of the actinic radiation by the phosphor will decrease absorption by the photoinitiators slowing or even preventing cure if the system is not carefully constructed.

### EXAMPLES

### LED Package

The LED package used in the examples comprised a polyphthalamide body injection molded onto an aluminum lead frame. The package had a 9×9 mm square base that was ˜2 mm thick and an additional 1.5 mm thick cylindrical section on top that was 8 mm in diameter. The package had an internal well that was 6 mm in diameter at the top of the well and ˜4 mm at the bottom of the well. The sidewall of the well was sloped at approximately a 70-degree angle and there was a small shelf in the sidewall between the top and bottom section of the well. The aluminum leads in the package were exposed at the bottom of the well, one large aluminum bond pad covering more than half of the base of the well and two smaller aluminum bond pads. The packages were not populated with LEDs.

### Preparation of Photopolymerizable Composition

To a 1 L Nalgene bottle was added 500.0 g of VQM-135 (vinyl Q-resin Dispersion in vinyl terminated polydiemethyl siloxane available from Gelest, Inc., Morrisville, Pa.) and 25.0 g of SYL-OFF 7678 Crosslinker (available from Dow Corning, Midland, Mich.). The two components were mixed thoroughly by hand to give a master batch of uncatalyzed silicone base. To a 500 mL Nalgene bottle was added 100.0 g of the silicone base above and 50 microliters of a solution of 33 mg of (trimethyl)methylcyclopentadienylplatinum (IV) (available from Alfa Aesar, Ward Hill, Mass.) in 1 mL of Toluene. The mixture was stirred thoroughly and was degassed under vacuum to remove entrapped air.

### Example 1

The package described above was filled with the photopolymerizable composition described above to be flush with the top of the well. The polyphthalamide package with photopolymerizable composition was irradiated for 140 seconds under a UVP Blak-Ray Lamp Model XX-15 fitted with two 16 inch Sylvania F15T8/350BL bulbs emitting primarily at 350 nm. After irradiation, the photopolymerizable composition, or encapsulant, had gelled and was very sticky. Onto the surface of the LED package and encapsulant was placed a small ˜9×9 mm square piece of a brightness enhancing film BEFII (available from 3M Company) with the linear prisms facing outward. The film appeared fully wetted with the encapsulant and was placed into a 120° C. oven for 10 minutes to finish curing the silicone encapsulant. After removing the package from the oven, it was visually inspected and the film was optically coupled to the encapsulant surface. The film was probed with a tweezer and was adhered to the surface of the encapsulant.

### Example 2

The package described above was filled with the photopolymerizable composition described above to be flush with the top of the well. The polyphthalamide package with photopolymerizable composition was irradiated for 140 seconds under a UVP Blak-Ray Lamp Model XX-15 fitted with two 16 inch Sylvania F15T8/350BL bulbs emitting primarily at 350 nm. After irradiation the encapsulant had gelled and was very sticky. Onto the surface of the LED package and encapsulant was placed a small ˜9×9 mm square piece of a multilayer optical film DBEF-E (available from 3M Company). The film appeared fully wetted with the encapsulant and was placed into a 120° C. oven for 10 minutes to finish curing the silicone encapsulant. After removing the package from the oven, it was visually inspected and the film was optically coupled to the encapsulant surface. The film was probed with a tweezer and was firmly attached to the surface of the encapsulant.

### Example 3

The package described above was filled with the photopolymerizable composition described above to be flush with the top of the well. The polyphthalamide package with photopolymerizable composition was irradiated for 140 seconds under a UVP Blak-Ray Lamp Model XX-15 fitted with two 16 inch Sylvania F15T8/350BL bulbs emitting primarily at 350 nm. After irradiation the encapsulant had gelled and was very sticky. Onto the surface of the LED package and encapsulant was placed a 6 mm half-ball lens made of BK7 glass (available from Edmund Industrial Optics). The lens appeared fully wetted with the encapsulant and was placed into a 120° C. oven for 10 minutes to finish curing the silicone encapsulant. After removing the package from the oven, the package was visually inspected and the lens was optically coupled to the encapsulant surface. The lens was probed with a tweezer and was firmly attached to the surface of the encapsulant.

The complete disclosures of the patents, patent documents, and publications cited herein are incorporated by reference in their entirety as if each were individually incorporated. Various modifications and alterations to the invention will become apparent to those skilled in the art without departing from the scope and spirit of the invention. It should be understood that the invention is not intended to be unduly limited by the illustrative embodiments and examples set forth herein, and that such examples and embodiments are presented by way of example only with the scope of the invention intended to be limited only by the claims set forth herein as follows.

What is claimed is:

1. A method of making a light emitting device, the method comprising:
providing a light emitting diode;
providing an optical element; and
attaching the optical element to the light emitting diode with a photopolymerizable composition, the photopolymerizable composition comprising a silicon-containing resin and a metal-containing catalyst, wherein the silicon-containing resin comprises silicon-bonded hydrogen and aliphatic unsaturation; and
applying actinic radiation having a wavelength of 700 nm or less to initiate hydrosilylation within the silicon-containing resin.

2. The method of claim 1 wherein the silicon-bonded hydrogen and the aliphatic unsaturation are present in the same molecule.

3. The method of claim 1 wherein the silicon-bonded hydrogen and the aliphatic unsaturation are present in different molecules.

4. The method of claim 1 wherein applying actinic radiation comprises applying actinic radiation at a temperature of 120° C. or less.

5. The method of claim 1 wherein the metal-containing catalyst comprises platinum.

6. The method of claim 5 wherein the metal-containing catalyst is selected from the group consisting of Pt(II) β-diketonate complexes, (η⁵-cyclopentadienyl)tri(σ-aliphatic)platinum complexes, and C₇₋₂₀-aromatic substituted (η⁵-cyclopentadienyl)tri(σ-aliphatic)platinum complexes.

7. The method of claim 3 wherein the photopolymerizable material comprises an organosiloxane comprising units of the formula:
R¹ₐR²_{b}SiO_{(4-a-b)/2}
wherein:
R¹ is a monovalent, straight-chained, branched or cyclic, unsubstituted or substituted, hydrocarbon group that is free of aliphatic unsaturation and has from 1 to 18 carbon atoms;
R² is a monovalent hydrocarbon group having aliphatic unsaturation and from 2 to 10 carbon atoms;
a is 0, 1, 2, or 3;
b is 0, 1, 2, or 3; and
the sum a+b is 0, 1, 2, or 3;
with the proviso that there is on average at least one R² present per molecule.

8. The method of claim 3 wherein the photopolymerizable material comprises an organosiloxane comprising units of the formula:
R¹ₐH_{c}SiO_{(4-a-c)/2}
wherein:
R¹ is a monovalent, straight-chained, branched or cyclic, unsubstituted or substituted, hydrocarbon group that is free of aliphatic unsaturation and has from 1 to 18 carbon atoms;
a is 0, 1, 2, or 3;
c is 0, 1, or 2; and
the sum of a+c is 0, 1, 2, or 3;
with the proviso that there is on average at least one silicon-bonded hydrogen present per molecule.

9. The method of claim 1 wherein the silicon-bonded hydrogen and the aliphatic unsaturation are present in a molar ratio of from 1.0 to 3.0.

10. The method of claim 1 wherein applying actinic radiation is carried out before attaching the optical element to the light emitting diode.

11. The method of claim 10 wherein at least 5 mole percent of the aliphatic unsaturation is consumed in a hydrosilylation reaction.

12. The method of claim 10 wherein at least 60 mole percent of the aliphatic unsaturation is consumed in a hydrosilylation reaction.

13. The method of claim 1 wherein applying actinic radiation is carried out after attaching the optical element.

14. The method of claim 13 wherein at least 5 mole percent of the aliphatic unsaturation is consumed in a hydrosilylation reaction.

15. The method of claim 13 wherein at least 60 mole percent of the aliphatic unsaturation is consumed in a hydrosilylation reaction.

16. The method of claim 1 wherein applying actinic radiation is carried out both before and after attaching the optical element.

17. The method of claim 1 further comprising heating at a temperature of 120° C. or less.

18. The method of claim 1 wherein the optical element comprises a polymer, glass, ceramic, or combination thereof.

19. The method of claim 1 wherein the optical element comprises a lens.

20. The method of claim 1 wherein the optical element comprises an optical film.

21. The method of claim 20 wherein the optical film comprises a reflective polarizing film, absorbing polarizing film, retro-reflective film, light guide, diffusive film, brightness enhancement film, glare control film, protective film, privacy film, or a combination thereof.

22. The method of claim 20 wherein the optical film comprises a short pass reflector or a long pass reflector.

23. The method of claim 22 wherein the optical film comprises a phosphor-reflector assembly, the phosphor reflector assembly comprising a layer of a phosphor material disposed a long pass reflector and a short pass reflector.

24. The method of claim 1 wherein the optical element comprises a brightness enhancement film having a microstructured surface, the microstructured surface comprising an array of prism elements.

25. The method of claim 1 wherein the optical element has a refractive index of about 1.75 or greater and comprises glass, diamond, silicone carbide, sapphire, zirconia, zinc oxide, polymer, or a combination thereof.

26. The method of claim 1 wherein attaching the optical element to the light emitting diode comprises contacting the optical element and light emitting diode.

27. The method of claim 1 wherein attaching the optical element to the light emitting diode comprises positioning the optical element within 100 nm of the light emitting diode.

28. The method of claim 1 wherein attaching the optical element to the light emitting diode comprises encapsulating the light emitting diode.

29. The method of claim 1 wherein the light emitting diode is mounted in a ceramic or polymeric package.

30. The method of claim 1 wherein the light emitting diode is mounted on a circuit board or a plastic electronic substrate.

31. The light emitting device prepared using the method of claim 1.
